(19) United States
(12) Patent Application Publication
(10) Pub. No.: US 2020/0040623 A1
(43) Pub. Date: Feb. 6, 2020

(54) Flat Pin Safe Lock System

(71) Applicant: Liberty Safe and Security Products, Inc., Payson, UT (US)

(72) Inventor: Terry D. Rasmussen, Payson, UT (US)

(21) Appl. No.: 16/053,447

(22) Filed: Aug. 2, 2018

(51) Int. Cl. E05C 9/06; E05B 65/00; E05G 1/04; E05C 9/00; E05C 9/22; E05G 1/026

(52) U.S. Cl. CPC E05C 9/063; E05B 65/0075; E05G 1/026; E05C 9/006; E05C 9/22; E05G 1/04

(57) ABSTRACT

A locking system for a door, such as a safe or security enclosure can include at least one locking pin bar assembly having flat locking pins or spades. The locking pin bar assembly is coupled to a lock mechanism by an actuator plate, which causes the locking pin bar assembly to extend outward into a locked position when the lock mechanism is actuated. The locking pin bar assembly includes a pin bar or flat plate that can be united with the one or more flat pins.

### FIELD OF THE TECHNOLOGY

The field of the invention relates generally to lock mechanisms for doors, and more specifically to pin bar assemblies installed into the doors of high-security enclosures such as safes.

### BACKGROUND OF THE TECHNOLOGY AND RELATED ART

When securing the door of a safe or other security enclosure, it is important to ensure that each possible method for opening the safe is guarded against unauthorized entry. In attempts to accomplish this, numerous different methods have been developed for ensuring that the door of the safe can not be easily opened, as the door is often the most vulnerable portion of the safe. If a burglar, thief or vandal is able to pry the door of the safe open, the structural integrity of the remainder of the safe or security enclosure becomes irrelevant. In attempts to overcome this concern, numerous arrangements have been made which cause a plurality of locking bolts or pins to extend from one or more sides of the door and into the remainder of the safe so as to prevent the door from being opened by prying, punching or some other externally-applied force.

While the use of locking bolts improves the security of the door, the present arrangements for engaging the locking bolts often provide insufficient protection, are difficult to operate, or are overly expensive. Other systems provide adequate protection, but are needlessly complex and have numerous moving parts which interact together in a rough or inefficient manner. If the parts fail, moreover, the owner of the safe can be unable to retrieve his or her belongings without unnecessary delay and the possibility of destroying the safe.

Thus, a need continues to exist for simple, efficient and more cost-effective lock mechanisms and methods for engaging the locking bolts on a safe door with the remainder of the safe.

### BRIEF DESCRIPTION OF THE DRAWINGS

The present technology will become more fully apparent from the following description and appended claims, taken in conjunction with the accompanying drawings. Understanding that these drawings merely depict exemplary aspects of the present technology they are, therefore, not to be considered limiting of its scope. It will be readily appreciated that the components of the present technology, as generally described and illustrated in the figures herein, could be arranged and designed in a wide variety of different configurations. Nonetheless, the technology will be described and explained with additional specificity and detail through the use of the accompanying drawings in which:

FIG. 1 is a back view of a lock system in accordance with one aspect of the technology;

FIG. 2 is a side view of the lock system of FIG. 1;

FIG. 3 is an isometric view of components of the lock system of FIG. 1;

FIG. 4 is a detailed side view of the lock system of FIG. 2;

FIG. 5 is an isometric view of the lock system of FIG. 4;

FIG. 6 is a front view of a pin bar assembly of the lock system of FIG. 1 in accordance with one aspect of the technology;

FIG. 7 is detailed isometric view of the pin bar assembly of FIG. 6;

FIG. 8 is a back view of a lock system in accordance with one aspect of the technology;

FIG. 9 is a back view of a lock system in accordance with another aspect of the technology;

FIG. 10 is a back view of a lock system in accordance with yet another aspect of the technology.

### DETAILED DESCRIPTION OF EXEMPLARY ASPECTS

The following detailed description of exemplary aspects of the technology makes reference to the accompanying drawings, which form a part hereof and in which are shown, by way of illustration, exemplary aspects in which the technology can be practiced. While these exemplary aspects are described in sufficient detail to enable those skilled in the art to practice the technology, it should be understood that other aspects can be realized and that various changes to the technology can be made without departing from the spirit and scope of the present technology. Thus, the following more detailed description of the aspects of the present technology is not intended to limit the scope of the technology, as claimed, but is presented for purposes of illustration only and not limitation to describe the features and characteristics of the present technology, to set forth the best mode of operation of the technology, and to sufficiently enable one skilled in the art to practice the technology. Accordingly, the scope of the present technology is to be defined solely by the appended claims.

The following detailed description and exemplary aspects of the technology will be best understood by reference to the accompanying drawings, wherein the elements and features of the technology are designated by numerals throughout.

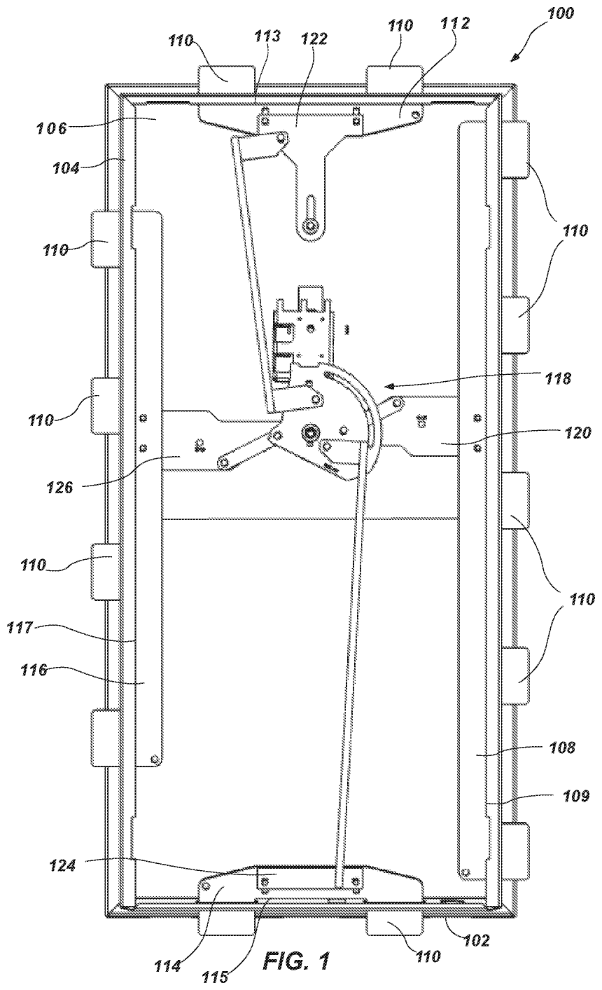

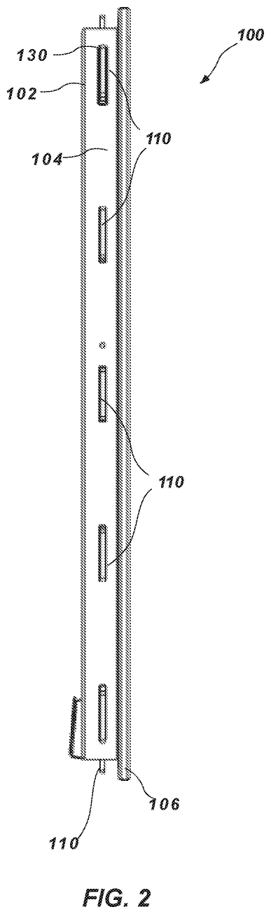

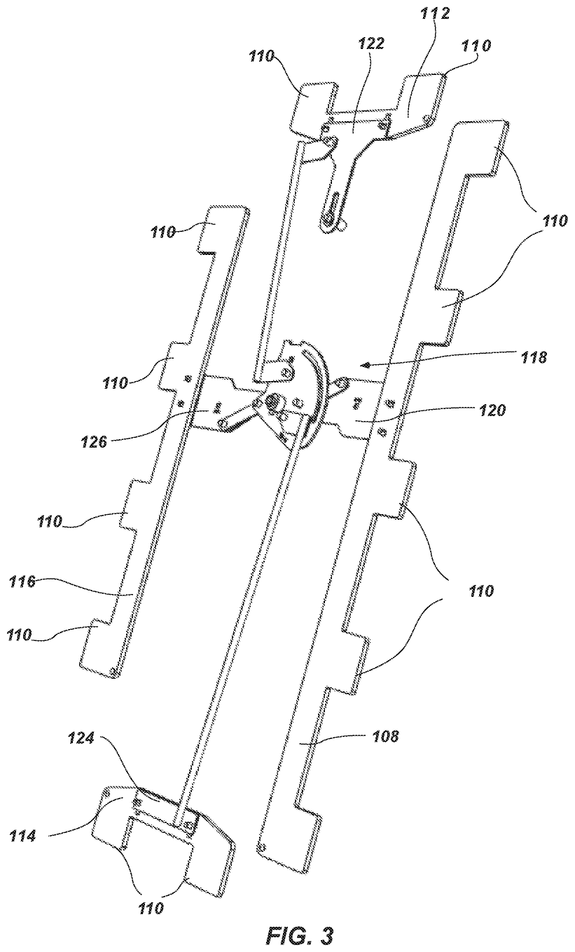

Illustrated in FIGS. 1-10 are several representative embodiments of a locking system for doors. The embodiments include various aspects and methods for engaging a door with a door frame using a locking pin bar assembly. As described herein below, aspects of the present disclosure, including locking pin bar assemblies having flat pins or spades rather than locking bolts or pins, provide several significant advantages and benefits over other door lock mechanisms and methods. For example, the present disclosure provides a system that is more resistant to prying because the flat pins or spades create more surface area and increase pry resistance of a door, while also including much fewer attachment points, which tend to be the leading cause of failure. However, the recited advantages are not meant to be limiting in any way, as one skilled in the art will appreciate that other advantages can also be realized upon practicing the invention.

FIGS. 1-3 show a locking system 100, in accordance with one aspect of the present disclosure. Locking system 100 can include a door 102, which can be a door of a security enclosure or safe, or any other door suitable for locking while employing the system disclosed herein. The door 102 can have a perimeter 104 adjacent the outer side edges of the door. The perimeter 104 provides both structural support for a door panel 106 and attachment points for hinges which can attach the door to a door frame (not shown), which can be the body of the safe or security enclosure. In one aspect of the present disclosure, the perimeter 104 is simply the outward facing edges of the door panel 106. In other aspects of the invention, the perimeter 104 extends from the back of the door panel 104. The door panel may be slightly larger in height and width than the perimeter to provide an overhang that covers any gap between the perimeter and door frame. Accordingly, the door perimeter 104 can be configured to fit tightly or securely within the door frame of the security enclosure or safe when closed so as to prevent the insertion of objects between the door and the door frame, which could be used to pry the two apart, and to restrict or eliminate the transfer of heat or air between the surrounding environment and the interior of the safe.

Locking system 100 can include one or more pin bar assemblies 109, 113, 115, 117. As shown in FIG. 1, for example, locking system 100 includes an open side pin bar assembly 109, a top side pin bar assembly 113, a bottom side pin bar assembly 115, and a hinge side pin bar assembly 117. Each pin bar assembly includes a flat plate or pin bar bracket 108, 112, 114, 116, and one or more flat pins or spades 110 that are movable between a locked and unlocked position through the perimeter of the door. For example, open side pin bar assembly 109 includes flat plate 108 and five flat pins 110 that extend horizontally from the vertically-oriented flat plate 108. Top side pin bar assembly 113 includes flat plate 112 and two flat pins 110 that extend vertically from the horizontally-oriented flat plate 112. Similarly, bottom side pin bar assembly 115 includes flat plate 114 and two flat pins 110 that extend vertically from the horizontally-oriented flat plate 114. As yet another example, hinge side pin bar assembly 117 includes flat plate 116 and four flat pins 110 that extend horizontally from the vertically-oriented flat plate 116. Other locking system configurations having different pin bar assembly arrangements, including fewer flat plates or a varying number of flat locking pins extending therefrom are also possible, and are considered to fall within the scope of the present invention. For example, a pin bar assembly can include a single flat locking pin, or can include six or more flat locking pins.

For each of the pin bar assemblies 109, 113, 115, 117, flat plates 108, 112, 114, 116 and flat pins 110 can be unitary, or formed as single body. For example, the pin bar assemblies can be formed from a single sheet of material, such as through a stamping manufacturing process, a machining manufacturing process, a forging manufacturing process or any other manufacturing process suitable for forming a single sheet of material into a pin bar assembly comprising a flat plate and one or more flat pins or spades. In other aspects of the present disclosure, the flat plates and flat pins can originate as separate materials, but be formed into a single, unitary piece, such as through welding. In yet other aspects of the present disclosure, the flat pins can be coupled to the flat plate in any method known in the art, such that the flat pins and the flat plate are separate but adjoined pieces.

The pin bar assemblies 109, 113, 115, 117 of locking system 100 can be formed from one of a variety of materials that can be suitable to provide the strength and pry resistance required by each application. For example, pin bar assemblies can be formed of steel or stainless steel. Pin bars or flat plates of the pin bar assemblies can take on a variety of sizes and shapes for each specific application. In one example, the flat plate can be rectangular with a constant width, as depicted by open and hinge side pin bar assemblies 109, 117, and extend any length desired based on the number of flat pins attached to the flat plate and the spacing between each flat pin. In other aspects of the present disclosure, the flat plate or pin bar can have a constant width between flat pins or spades, but gradually decrease in width or taper inward at the location of each flat pin or spade near the ends of the flat plate, as depicted by top and bottom side pin bar assemblies 113, 115. The pin bars or flat plates can have a consistent thickness with the flat pins or spades, or one or the other can have a larger or smaller thickness depending on the desired application. For example, the pin bar or flat plate can be thicker than the flat pins or spades to provide additional prying resistance at the pin bar. In another example, the flat pins or spades can be thicker than the pin bar or flat plate to provide additional prying resistance and the pins themselves. In one example of the present disclosure, the pin bar assemblies 109, 113, 115, 117 include flat plates and flat pins that have the same thickness, and are selected from thicknesses including three-sixteenths inch ( 3/16″), one quarter inch (¼″), five-sixteenths inch ( 5/16″), three-eights inch (⅜″), seven-sixteenths inch ( 7/16″), one half inch (½″) and five-eights inch (⅝″). For example, in one aspect of the present disclosure, pin bar assemblies 109, 113, 115, 117 are formed from a quarter-inch steel plate.

The geometry of flat pins 110 can be chosen to suit individual applications and remain consistent with aspects of the presently disclosed locking system 100. Flat pins 110 extend outwardly from the flat plate or pin bar a certain distance representing the height of the flat pin, and extend along the flat plate a certain distance representing the width of the flat pin. In aspects of the present disclosure, flat pins 110 are rectangular, with the width of the flat pin greater than the height of the flat pin. For example, the ratio of the width to the height of the flat pin can be expressed as 1.5, or that the width of the flat pin is 1.5 times greater than the height of the flat pin. In aspects of the present invention, the ration of the width to the height of the flat pin can be 1.1, 1.2, 1.3, 1.4, 1.5, 1.6, 1.7, 1.8, 1.9, 2.0, 2.5, 3, 3.5 or 4.0. For example, the flat pin can have a height of 2 inches and a width of 3 inches, having a 1.5 ration of the width to the height. In other aspects, the flat pin can be square, having a 1.0 ratio of the width to the height. In yet other aspects of the present invention, the flat pin or spade can be semi-circular or have one or more curved surfaces, or can be any polygonal shape suited for a particular application.

According to aspects of the present disclosure, pin bar assemblies 109, 113, 115, 117 are coupled to a lock mechanism 118 that is disposed on an inside of door 102. For example, open side pin bar assembly 109 is coupled to lock mechanism 118 by actuator plate 120. Similarly, actuator plate 122 couples top side pin bar assembly 113 to lock mechanism 118, actuator plate 124 couples bottom side pin bar assembly 115 to lock mechanism 118, and actuator plate 126 couples hinge side pin bar assembly 117 to lock mechanism 118. Lock mechanism 118 can be any lock mechanism known in the art. It is known in the art that various different lock mechanism comprising different parts provide the movement necessary to engage the flat pins of the pin bar assemblies with a door frame to lock the door. For example, lock mechanism 118 can include a series of cams and linkage bars to translate rotational actuation of the lock mechanism into linear movement of the actuator plates 120, 122, 124, 126, as known in the art. Other examples of lock mechanisms and actuator plates consistent with the present disclosure will be known and understood by those of skill in the art.

As will be understood, the locking system 100 of the present disclosure provides for pins 110 to move between an unlocked position and a locked position. In other words, the at least one flat pin is movable between a locked and unlocked position through the perimeter of the door. In the unlocked position, the pins are hidden within perimeter 104 and clear of the door frame so that the door can be opened and shut. In the locked position, the pins extend through perimeter 104 and engage a door frame to secure the door in a closed position.

The depth of the perimeter 104 of the door 102 relative to the door frame of the safe or security enclosure can be arranged so that the locking pins 110 are located interior to an inside perimeter side edge (not shown) of the door frame when the door 102 is in the closed position. As will be understood by one of skill in the art, actuating the pin bar assemblies 109, 113, 115, 117 with the lock mechanism 118 can extend the locking pins radially outward behind the inside perimeter side edge of the door frame to lock the safe and prevent the door from opening.

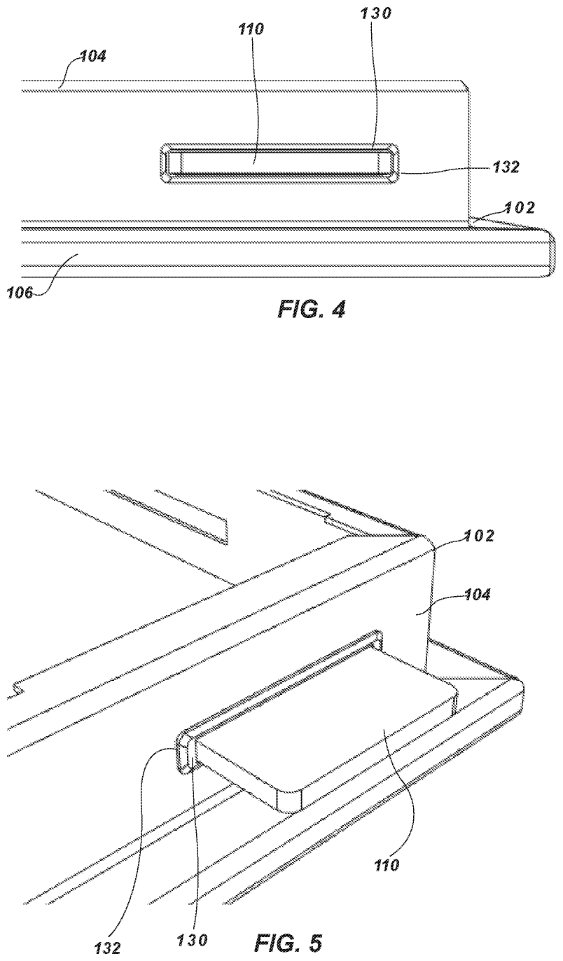

With reference to FIGS. 4-5, the perimeter 104 of the door 102 can further include locking pin apertures or slots 132 that are periodically spaced along one or more side edges of the door, and which slidably support the plurality of locking pins 110 extending from the pin bar assemblies 109, 113, 115, 117. A pin guide 130 can be disposed within the perimeter 104 of the door 102 about the pin 110. In other words, a pin guide 130 can be disposed in each aperture or slot 132 about each flat pin 110 to provide further support and integrity to the position of locking pins 110. For example, pin guides 130 can provide the required tolerances for the placement of flat pins 110 to ensure that the flat pins correctly engage a door frame. Moreover, pin guides 130 can provide stability to the flat pin 110 in the extended position, reducing the amount of movement between the pin and the perimeter of the door, which in turn reduces the play or movement available to an individual attempting to pry open the door.

Pin guide 130 can be formed by a single piece of material or can be assembled from multiple parts to create a uniform pin guide. For example, pin guide 130 can be an injection-molded plastic piece that can be a single piece that snaps into aperture or slot 132, or that can be two or more pieces. For example, pin guide 130 can include two pieces that snap together when each is positioned through an opposite side of aperture or slot 132. In other examples, pin guide 130 can be formed from one or more pieces of metal, and can similar be assembled when each piece is placed in the correct position within aperture or slot 132.

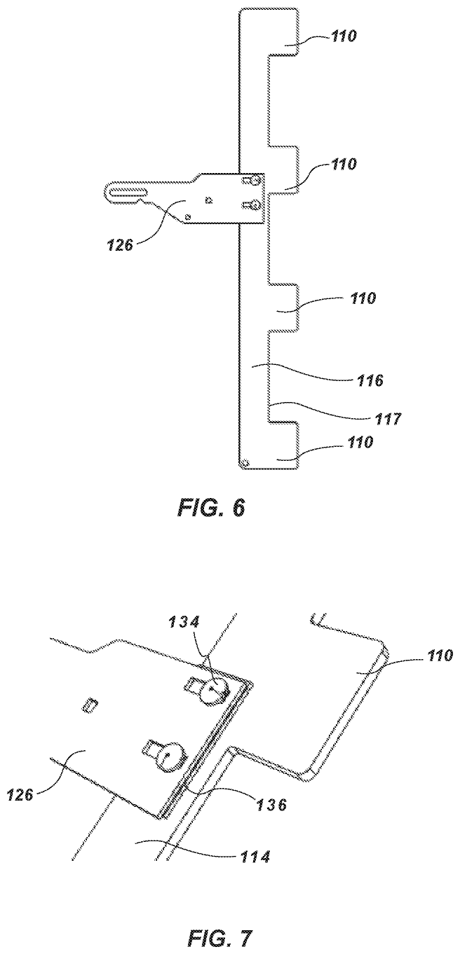

FIGS. 6-7 depict the coupling of a pin bar assembly to an actuator bar adapted to interact with a lock mechanism. As an example, hinge side pin bar assembly 117, which includes flat bar 116 and four flat pins 110, can be coupled to actuator bar 126. One or more fasteners 134 can be used to couple pin bar assembly 117 to actuator bar 126. It will be understood that fastener 134 can be the first point of failure for locking system 100 under prying conditions when flat pins 110 and flat bar 116 are unitary and do not present failure points under prying conditions. As such, fastener 134 will be selected to withstand the loads of specific applications, as understood by those of skill in the art.

In aspects of the present locking system, a spacer plate 136 can be disposed between actuator plate 126 and flat plate 114 of pin bar assembly 117. The spacer plate can fortify the connection between the actuator plate and the pin bar assembly, and can also serve to provide selectable spacing or offsetting of the pin bar assemblies from the actuator plates. For example, the same actuator plates and pin bar assemblies can be employed in a variety of settings, including safes and safety enclosures, each of which can require slightly different spacing between the lock mechanism 118 and the apertures 132 in the perimeter 104 of the door 102. The thickness of spacer plate 136 can be chosen to provide accurate alignment between the actuator plate 126 and the lock mechanism 118, as well as between the flat pins 110 of the pin bar assembly 117 and the apertures 132 in the perimeter 104 of the door 102.

Those of ordinary skill will understand that the coupling described above can apply to various pin bar assemblies and to various configurations for coupling the pin bar assemblies to the lock mechanism of a locking system such as a safe or security enclosure.

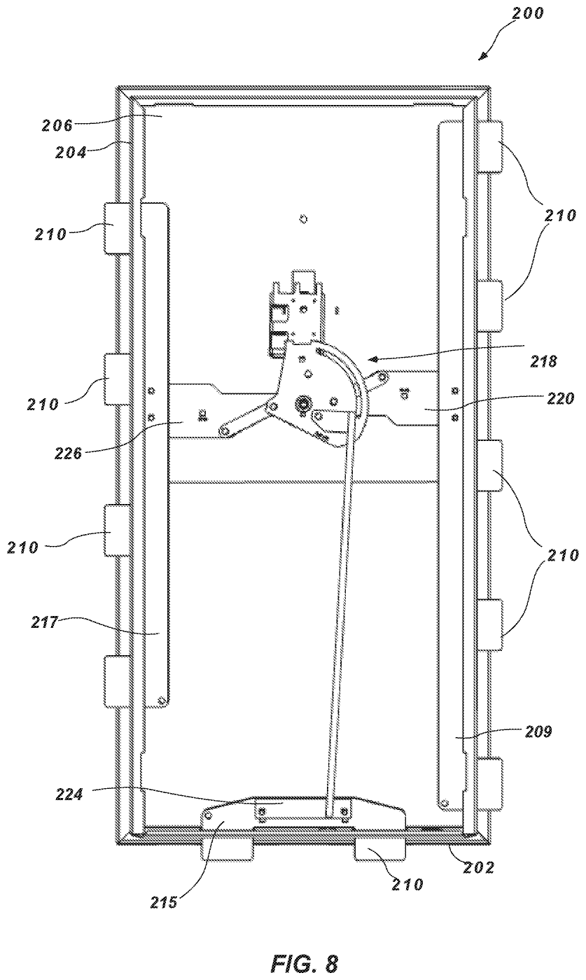

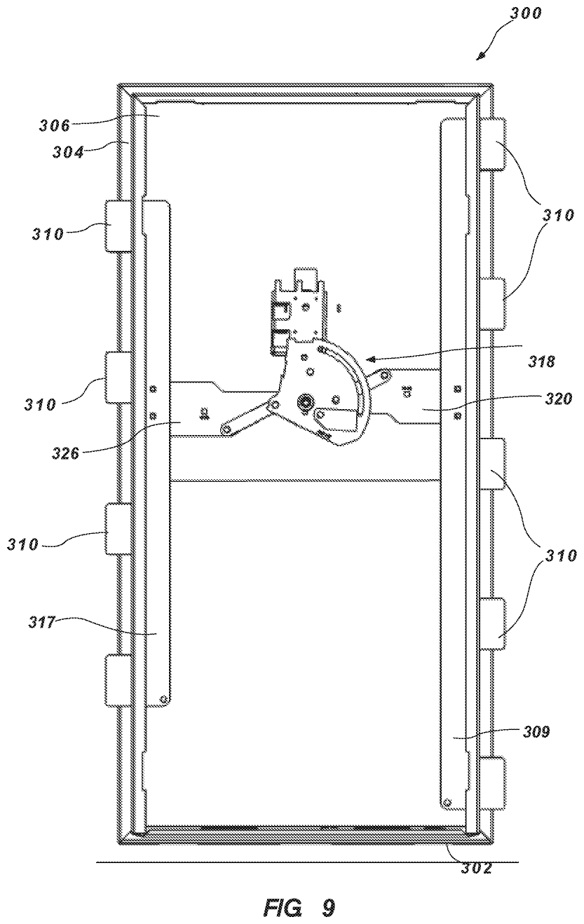

According to other aspects of the invention, FIG. 8 illustrates a three-sided locking system 200 including three pin bar assemblies. Door 202 of locking system 200 includes a perimeter 204 and insert 206, consistent with previously disclosed aspects. In one example, locking system 200 includes only an open side pin bar assembly 209, a bottom side pin bar assembly 215 and a hinge side assembly 217. As described more fully herein, each of the pin bar assemblies 209, 215, 217 are coupled to a lock mechanism 218 by actuator plates 220, 224, 226. It will be understood that pin bar assemblies 209, 215, 217 can include any number of flat locking pins 210 as desired for particular applications. It will also be understood that a locking system utilizing three pin bar assemblies can include a top pin bar assembly (not pictured), and instead omit one of the open side, bottom side, or hinge side pin bar assemblies to create a locking system including three pin bar assemblies.

According to yet other aspects of the invention, FIG. 9 illustrates a two-sided locking system 300 including two pin bar assemblies. Door 302 of locking system 300 includes a perimeter 304 and insert 306, consistent with previously disclosed aspects. In one example, locking system 300 includes only an open side pin bar assembly 309 and a hinge side assembly 317. As described more fully herein, each of the pin bar assemblies 309, 317 are coupled to a lock mechanism 318 by actuator plates 320, 326. It will be understood that pin bar assemblies 309, 317 can include any number of flat locking pins 310 as desired for particular applications. It will also be understood that a locking system utilizing two pin bar assemblies can include a top pin bar assembly or a bottom pin bar assembly (not pictured), and instead omit one of the open side or hinge side pin bar assemblies to create a locking system including three pin bar assemblies.

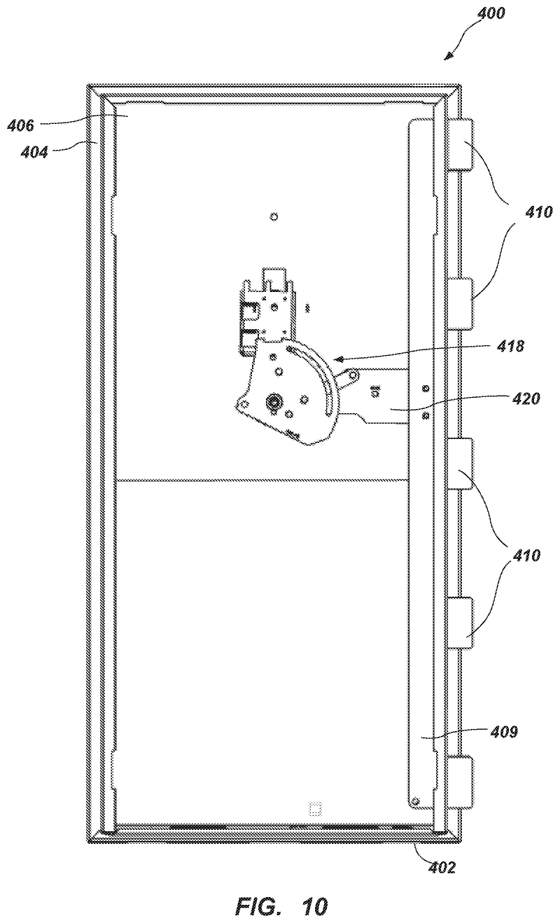

In accordance with another aspect of the present disclosure, FIG. 10 illustrates a single-sided locking system 400 including a single pin bar assembly. Similar to the apparatus described above, door 402 of locking system 400 includes a perimeter 404 and insert 406, consistent with previously disclosed aspects. In one example, locking system 400 includes only an open side pin bar assembly 409. As described more fully herein, pin bar assembly 409 is coupled to a lock mechanism 418 by actuator plate 420. It will be understood that pin bar assembly 409 can include any number of flat locking pins 410 as desired for particular applications. It will also be understood that a single-sided locking system utilizing a single pin bar assembly can include a top side pin bar assembly, a bottom side pin bar assembly, or a hinge side assembly (not pictured), and instead omit the open side pin bar assembly to create a single-sided locking system including one pin bar assembly.

According to aspects of the present disclosure, as will be understood by those of skill in the art, a method for engaging a door with a door frame is disclosed herein. The method includes actuating a lock mechanism mounted to a door, the lock mechanism coupled to one or more actuator plates. The method further includes causing the one or more actuator plates to move one or more pin bar assemblies outward from the center of the door, the one or more pin bar assemblies comprising one or more flat pins. The method also includes causing the one or more flat pins to extend through a corresponding slot in a perimeter of the door and engage a door frame.

In aspects of the present disclosure, the method also includes use of a pin guide, such that each slot of in the perimeter of the door includes a pin guide. In other aspects, the one or more pin bar assemblies further includes a flat plate, and the flat plate and the one or more flat pins are unitary or formed of one piece. Other aspects of the method inherent in the present disclosure will be understood by those skilled in the art.

In other aspects of the present disclosure, the method also includes mounting a lock mechanism to a door, coupling the lock mechanism to one or more actuator plates, and coupling the one or more actuator plates to one or more pin bar assemblies comprising one or more flat pins. In the present method, the actuation of the lock mechanism causes the lock mechanism to drive the actuator plate outward causing the one or more flat pins to extend through a slot in a perimeter of the door and engage a door frame.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims can be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. A door locking system, comprising:
a door having a perimeter;
a lock mechanism disposed on an inside of the door;
at least one pin bar assembly coupled to the lock mechanism by an actuator plate, the pin bar assembly comprising at least one flat pin movable between a locked and unlocked position through the perimeter of the door.

2. The locking system of claim 1, wherein the pin bar assembly further comprises a flat plate.

3. The locking system of claim 2, wherein the flat plate and the at least one flat pin of the pin bar assembly are unitary.

4. The locking system of claim 1, wherein the at least one pin bar assembly comprises an open side pin bar assembly, a hinged side pin bar assembly, a top side pin bar assembly, and a bottom side pin bar assembly.

5. The locking system of claim 1, wherein the at least one pin bar assembly is an open side pin bar assembly.

6. The locking system of claim 5, wherein the open side pin bar assembly comprises five flat pins.

7. The locking system of claim 1, further comprising a door frame, wherein the at least one pin of the at least one pin bar assembly engages a door frame.

8. The locking system of claim 7, further comprising a pin guide disposed within the perimeter of the door about the pin.

9. The locking system of claim 7, wherein the door and the door frame further comprise a door and a door frame of a safe.

10. A safe door, comprising:
a door perimeter disposed about the outer edges of the door and adapted to fit securely within a door frame of the safe;
a lock mechanism disposed on an inside of the door; and
at least one pin bar assembly coupled to the lock mechanism by an actuator plate and comprising at least one flat pin movable between a locked and unlocked position through the door perimeter;
wherein actuation of the lock mechanism causes the lock mechanism to drive the actuator plate outward and engage the flat pin of the pin bar assembly with the door frame of the safe.

11. The safe door of claim 10, wherein the at least one pin bar assembly further comprises a flat plate.

12. The locking system of claim 11, wherein the flat plate and the at least one flat pin of the at least one pin bar assembly are united.

13. The locking system of claim 11, wherein the at least one pin bar assembly comprises an open side pin bar assembly, a hinged side pin bar assembly, a top side pin bar assembly, and a bottom side pin bar assembly.

14. The locking system of claim 11, wherein the at least one pin bar assembly comprise an open side pin bar assembly.

15. The locking system of claim 14, wherein the open side pin bar assembly comprises five flat pins.

16. The locking system of claim 10, wherein the door perimeter comprises a pin slot corresponding to each of the at least one flat pins of the at least one pin bar assembly.

17. The locking system of claim 16, further comprising a pin guide disposed in each of the pin slots.

18. A method of engaging a door with a door frame, comprising:
mounting a lock mechanism to a door,
coupling the lock mechanism to one or more actuator plates; and
coupling the one or more actuator plates to one or more pin bar assemblies comprising one or more flat pins;
wherein actuation of the lock mechanism causes the lock mechanism to drive the actuator plate outward causing the one or more flat pins to extend through a slot in a perimeter of the door and engage a door frame.

19. The method of claim 18, wherein each slot in the perimeter of the door comprises a pin guide.

20. The method of claim 18, wherein the one or more pin bar assemblies further comprise a flat plate, and wherein the flat plate and the one or more flat pins are united.
